(19) United States
(12) Patent Application Publication
(10) Pub. No.: US 2008/0018138 A1
(43) Pub. Date: Jan. 24, 2008

(54) Rail Systems for Securing a Roofing Sheet to a Structure

(76) Inventor: Dennis R. Vance, Edwardsburg, MI (US)

Correspondence Address: BAKER & DANIELS LLP, 300 NORTH MERIDIAN STREET, SUITE 2700, INDIANAPOLIS, IN, 46204, US

(21) Appl. No.: 11/779,679

(22) Filed: Jul. 18, 2007

Related U.S. Application Data
(60) Provisional application No. 60/807,868, filed on Jul. 20, 2006.

(51) Int. Cl. B60R 27/00

(52) U.S. Cl. 296/203.01

(57) ABSTRACT

The present invention includes a rail system for securing a roofing sheet to a structure having a roof and at least one wall. The rail system includes a rail and a clamping member. The rail includes a wall mounting portion, a ledge extending from a lower portion of the wall mounting portion and a lip extending from the wall mounting portion and forming a recess between the lip and the wall mounting portion. The wall mounting portion is adapted to be mounted on the wall of the structure. The clamping member has a first end and a second end. When the roofing sheet is positioned over the rail, the first end of the clamp member fits within the recess and the opposing second end presses the roofing sheet against the ledge to thereby hold the clamp to the rail by interference fit and to clamp the roofing sheet between the rail and the clamping member.

### BACKGROUND

The present invention relates to roof systems for recreational vehicles, campers, mobile homes and other structures and, more particularly, to rail systems for securing roofing materials.

Recreational vehicles (RV's), campers, mobile homes, fifth wheels and other mobile structures typically include a plurality of walls defining the interior footprint of the structure and a roof extending between the walls. These structures often include a waterproof sheet of roofing material covering the roof. This waterproof sheet extends over the roof and down a portion of the walls thereby covering the joint where the walls meet the roof. Rigid rails are used to secure the ends of the waterproof roofing sheet to the walls. These rails typically run the length of the walls. The rail is positioned on top of the waterproof roofing sheet and are fastened to the underlying wall using screws. The screws extend through the rail, through the roofing sheet and into the wall.

These rails often include gutter channels to help funnel water from the roof to a downspout. However, because the rail is positioned on top of the roofing sheet and the screws extend through both the roofing sheet and rail and into the wall, water can leak in between the rail and the roof sheet. Ultimately, water may leak into and down the wall. To prevent water leakage, caulking is placed at the seam between the rail and the roof material. Although effective, it would be beneficial to have a rail system that provides a more efficient means of securing the roofing sheet to the structure.

### SUMMARY

The present invention provides rail systems for securing a roofing sheet to a structure having a roof and at least one wall. The rail system generally includes a rail and a clamping member. The rail includes a wall mounting portion, a ledge extending from a lower portion of the wall mounting portion and a lip extending from the wall mounting portion and forming a recess between the lip and the wall mounting portion. The wall mounting portion is adapted to be mounted on the wall of the structure. The clamping member has a first end and an opposing second end. When the roofing sheet is positioned over the rail, the first end of the clamp member fits within the recess and the opposing second end presses against the ledge to thereby hold the clamp to the rail by interference fit and to clamp the roofing sheet between the rail and the clamping member.

In an additional aspect, either the ledge of the rail or the second end of the clamping member may form a curved gutter. The rail and clamp member may also include a tooth to further grip the roofing sheet. Either the ledge of the rail or the second end of the clamp member may include a bead. The other of the ledge and the second ledge may include a groove configured to mate with the bead to further secure clamp to the rail.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a partial sectional view of an RV having a rail system in accordance with one embodiment of the present invention;

FIG. 2 is a sectional view of the rail system of FIG. 1 clamping the roof material of the RV;

FIG. 3 is a sectional view of the rail system of FIG. 2;

FIG. 4 is a sectional view of a rail system in accordance with another embodiment of the present invention;

FIG. 5 is a sectional view of a rail system in accordance with a third embodiment of the present invention;

FIG. 6A is a sectional view of a rail of a rail system in accordance with a further embodiment of the present invention;

FIG. 6B is a sectional view of a rail of a rail system in accordance with a fifth embodiment of the present invention;

FIG. 6C is a sectional view of a rail of a rail system in accordance with a sixth embodiment of the present invention;

FIG. 6D is a sectional view of a rail of a rail system in accordance with a seventh embodiment of the present invention;

FIG. 7 is a sectional view of a clamp member for use with the rail systems of FIGS. 6A-6D;

FIG. 8 is a sectional view of a rail system in accordance with still an eighth embodiment of the present invention; and

FIG. 9 is a sectional view of a rail system in accordance with a ninth embodiment of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

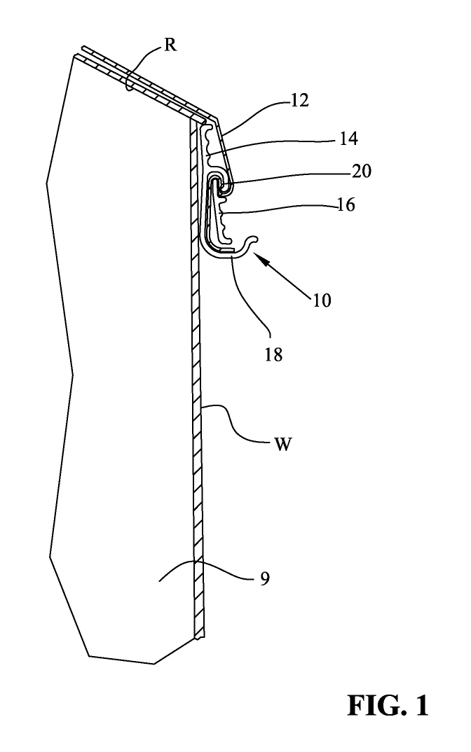

Referring first to FIG. 1, recreational vehicle (RV) 9 is illustrated having wall W and roof R. Roof sheet 12 covers roof R, and extends over the edge of roof R and downward over a portion of wall W adjacent roof R. Roof sheet 12 may be made of any suitable roofing material including, for example, a waterproof rubber or plastic material. Rail system 10 is mounted to wall W and extends along the length of wall W adjacent roof R. Rail system 10 secures roof sheet 12 in position over roof R.

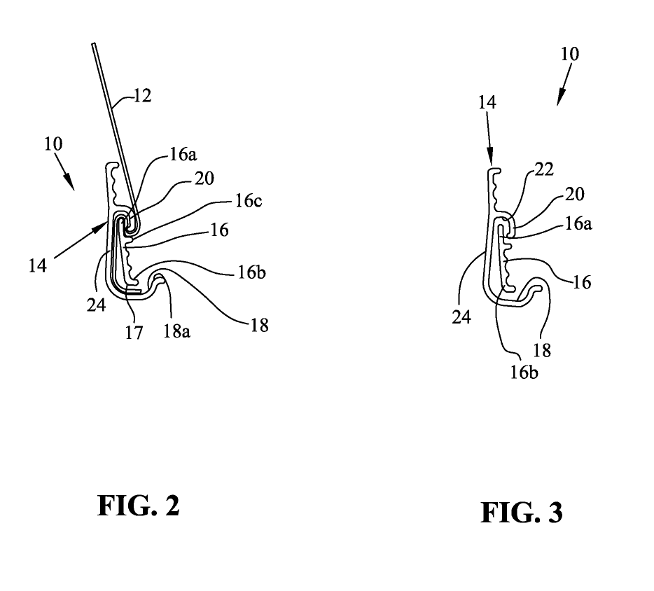

Turning now to FIGS. 1-3, rail system 10 includes rail 14 and clamp member 16. Rail 14 includes a substantially flat wall mount portion 24 adapted to seat against and be mounted to wall W. Wall portion 24 may be mounted to wall W using any means including using adhesive, screws, nails and welding. Rail 14 forms a curved gutter or run-off channel 18 at the lower end that, as discussed in further detail below, runs the length of wall W and acts as a rain gutter to direct flow of water from roof R. Rail 14 also includes lip 20 projecting outwardly from wall mount portion and downwardly to form clamp receiving recess 22.

Referring still to FIGS. 1-3, clamp member 16 includes first end 16a and opposing second end 16b. In use, rail 14 is mounted to wall W of RV 9 such that wall mount portion 24 is seated against wall W and gutter 18 and lip 20 extend outwardly from wall W. Roof sheet 12 is positioned over roof R such that the ends of roof sheet 12 extend downwardly over both wall W and rail 14. First end 16a of clamp member 16 is inserted into recess 22 formed by lip 20 thereby clamping roof sheet 12 between lip 20 and clamp member 16. Second end 16b is then press fit into gutter 18 of rail 14 thereby securing roof sheet 12 to rail 124 by interference fit. To facilitate the press fitting of second end 16b in gutter 18, gutter 18 may have curved edge 18a and clamp 16 may have curved surface portion 17. As second end 16b of clamp member 16 is forced into gutter 18 curved edge 18a slides against curved surface portion 17. Clamp member 16 may also include ridge 16c to provide further clamping of roof sheet 12.

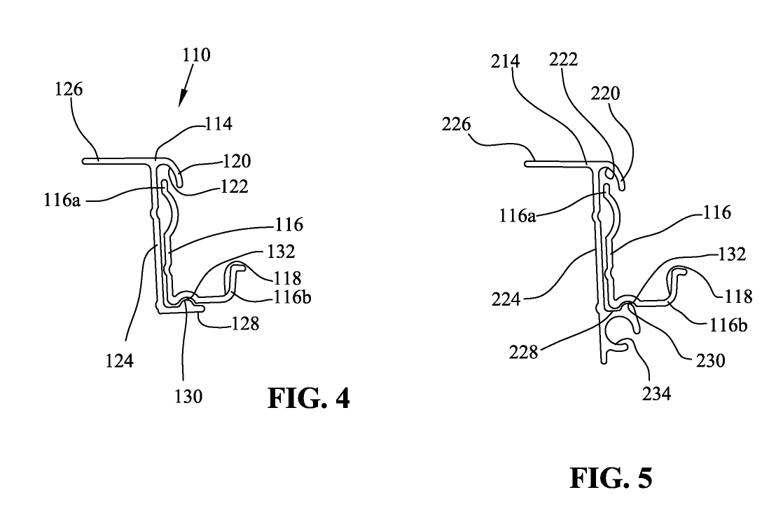

Turning now to FIG. 4, another embodiment of a rail system is shown. Rail system 110 generally includes rail 114 and clamp member 116. Rail 114 includes wall mounting portion 124 adapted to be seated against and mounted on a wall (not shown) of an RV (not shown), as discussed above. Rail 114 forms lip 120 at its upper end and lower ledge 128 at its lower end. Lip 120 extends outwardly and downwardly to form recess 122. Lower ledge 128 extends outwardly from wall mounting portion 124 and includes bead 130 projecting from the upper surface of ledge 128. Rail 114 includes upper ledge 126 adapted to extend over the roof (not shown) when wall mounting portion 124 is mounted on the wall (not shown) of the RV (not shown).

Clamp member 116 includes first end 116a and second end 116b. First end 116a is sized to fit within recess 122 while clamping the roof sheet (not shown) between clamp member 116 and rail 114 in recess 122. Second end 116b of clamp 116 forms gutter 118, which can act to direct water flowing from the roof (not shown) of the RV (not shown). The bottom surface of second end 116b includes groove 132 configured to receive bead 130.

Use of rail system 110 is similar to that of rail system 10. That is, rail 114 is mounted to the wall (not shown) of the RV (not shown) and the end of the roof sheet (not shown) is positioned over rail 114. With roof sheet (not shown) positioned over rail 114, first end 116a of clamp member 116 is inserted into recess 122 thereby clamping the roof sheet (not shown) between rail 114 and clamp member 116. Second end 116b of clamp member 116 is then snapped into place over lower ledge 128 of rail 114 such that bead 130 is received in groove 132, thereby securing clamp 116 and roof sheet (not shown) to rail 114.

Turning now to FIG. 5, clamp member 116 may be used with alternative rail designs such as rail 214. Rail 214 is similar to rail 114 in that rail 214 includes wall mounting portion 224, upper ledge 226, lower ledge 228 and lip 220. Mounting portion 224 is adapted to seat against and mount to a wall of an RV (not shown). Upper ledge 226 is adapted to extend over the roof (not shown) of the RV when rail 214 is mounted to the wall (not shown) of the RV (not shown). Lower ledge 228 includes bead 230 which projects upwardly from the upper surface of lower ledge 228 and extends along the length of lower ledge 228. Lip 220 extends outwardly from wall mounting portion 224 and downwardly to form recess 222. Rail 214 also includes C-shaped channel 234 formed beneath lower ledge 228. Channel 234 is adapted to receive fixtures for attachment to the wall (now shown) of the RV (not shown). Clamp member 116 is used with rail 214 in the manner discussed above to secure the roof sheet (not shown) to the RV (not shown).

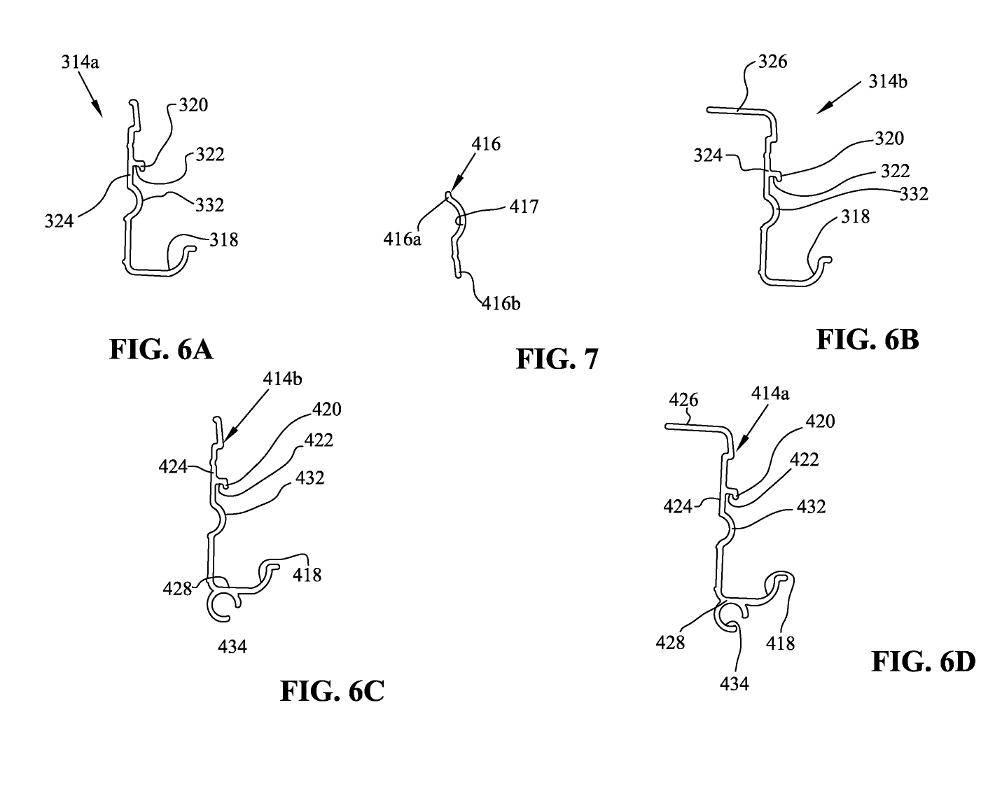

Referring now to FIGS. 6A-6D and 7, FIGS. 6A-6D illustrate a variety of rails 314a, 314b, 414a, 414b in accordance with the present invention, while FIG. 7 illustrates clamp member 416 that may be used with any of rails 314a, 314b, 414a, 414b.

Turning first to FIGS. 6A and 6B, rails 314a, 314b each include wall mounting portion 324, gutter 318 extending outwardly from the lower end of wall mounting portion 324, and lip 320 extending from wall mounting portion to form recess 322. Rails 314a, 314b each includes projection or bead 332 extending from wall mounting portion 324. Rail 314b (FIG. 6B) also includes upper ledge 326, which is adapted to extend over the roof (not shown) of the RV (not shown) when rail 314b is mounted to the RV.

Turning to FIGS. 6C and 6D, each of rails 414a, 414b include wall mounting portion 424, gutter 418 extending outwardly from wall mounting portion 424, lip 420 extending from wall mounting portion 424 to form recess 422 and C-shaped channel 434 formed beneath gutter 418 and adapted to couple a fixture (not shown) to the RV (not shown). Each of rails 414a, 414b also include bead or projection 432. Rail 414a includes upper ledge adapted to extend over the roof (not shown) of the RV (not shown) when wall mounting portion 424 of rail 414a is mounted to the RV (not shown).

FIG. 7 illustrates clamp member 416, which may be used with any of rails 314a, 314b, 414a, 414b of FIGS. 6A-6D. Clamp member 416 includes first end 416a, opposing second end 416b and groove 432 disposed between first and second ends 416a, 416b. First end 416a is configured to be received in either of recesses 322, 422 of rails 314a, 314b, 414a, 414b. Groove 432 is configured to receive either of beads 332, 432 to provide further clamping of the roof sheet (not shown) between rail 314a, 314b, 414a, 414b and clamp 416. Clamp member 416 may be used with any of rails 314a, 314b, 414a, 414b as described above to secure a roof sheet (not shown) to an RV (not shown).

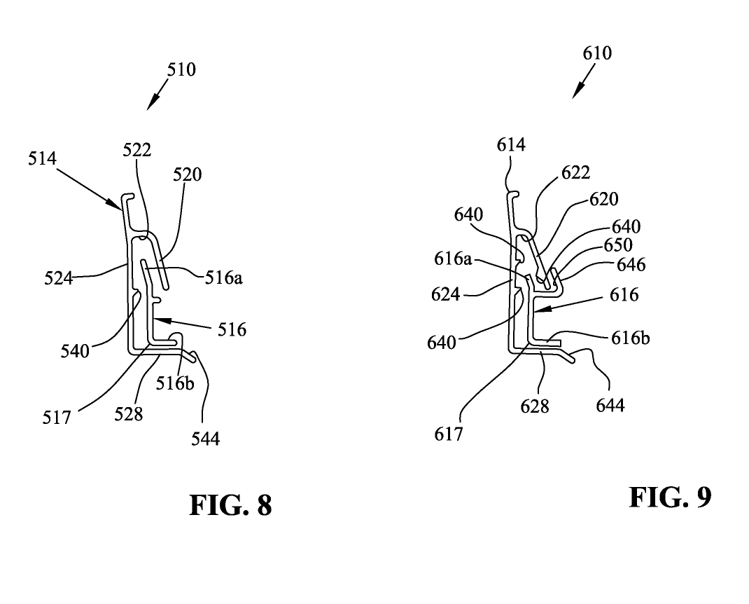

Turning now to FIG. 8, alternative rail system 510 is shown. Rail system 510 generally includes rail 514 and clamp member 516. Rail 514 includes wall mounting portion 524, lower ledge 528 extending outwardly from wall mounting portion 524 and lip 520 extending from wall mounting portion 524 to form recess 522. Ledge 528 includes ramped surface 544, which slopes downward from ledge 528. Rail 514 also includes tooth 540 extending from wall mounting portion 524 between ledge 528 and lip 520.

Clamp member 516 includes upper end 516a and opposing lower end 516b. Lower end 516b forms curved bend 517. In use, rail 514 is mounted to the wall (not shown) of an RV (not shown), as discussed above, such that mounting portion 524 is seated against the wall and ledge 528 extends outwardly from the wall. The roofing sheet (not shown) is placed over roof and extends over rail 514, similar to the manner described above with respect to FIG. 1. With the roofing sheet (not shown) overlying rail 514, first end 516a of clamp member 516 is inserted into recess 522 formed by lip 520, thereby clamping the roof sheet (not shown) between clamp member 516 and rail 514. Second end 516 of clamp member 516 is then snapped into place above ledge 528. Ramped surface 544 of rail 514 and curved bend 517 of clamp member 516 slide against one another to facilitate and guide the positioning of second end 516b over ledge 528. In this position, clamp 516 clamps the roof sheet (not shown) to rail 514. Tooth 540 grips the roof sheet (not shown) to provide further clamping.

Referring now to FIG. 9, alternative rail system 610 is illustrated. Rail system 610 generally includes rail 614 and clamp member 616. Rail 614 includes wall mounting portion 624, lower ledge 628 extending outwardly from wall mounting portion 624, lip 620 and teeth 640. Lip 620 protrudes outwardly from mounting portion 624 to form recess 622 between lip 620 and mounting portion 624. Ledge 628 includes sloped surface 644, which slopes downward from ledge 628. Teeth 640 are disposed on both lip 620 and wall mounting portion 624.

Clamp member 616 includes first end 616a and opposing second end 616b. Second end 616b forms curved bend 617. Tab 640 extends from clamp member 616 near first end 616a. First end 616a cooperates with tab 646 to define recess 650. Recess 650 is configured to receive lip 620, while first end 616a is configured to be received in recess 622. Use of rail system 610 is similar to the use of rail system 510 of FIG. 8. Recess 650 receives lip 620 to provide added clamping and securing of roof sheet (not shown).

The components of the rails systems of the present invention may be made of any material suitable for securing a roof sheet to a structure. For example, the rail and clamp member of the rail system may be formed of plastic or metal and may be formed by molding or extrusion processes.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A rail system for securing a roofing sheet to a structure having a roof and at least one wall, said rail system comprising:
a rail having a wall mounting portion, a ledge extending from a lower portion of said wall mounting portion and a lip extending from said wall mounting portion and forming a recess between said lip and said wall mounting portion, said wall mounting portion adapted to be mounted on the wall of the structure; and
a clamping member having a first end and an opposing second end;
wherein when the roofing sheet is positioned over said rail, said first end of said clamp member fits within said recess and said opposing second end presses the roofing sheet against said ledge to thereby clamp the roofing sheet between said rail and said clamping member to secure said roofing sheet to said rail.

2. The rail system of claim 1 wherein said ledge forms a curved gutter.

3. The rail system of claim 1 wherein said second end of said clamping member includes a curve gutter.

4. The rail system of claim 1 wherein said rail includes at least one tooth adapted to grip the roofing sheet.

5. The rail system of claim 1 wherein in one of said ledge and said second edge includes a bead and the other of said ledge and said second end includes a groove, said groove mating with said bead to further secure clamp to said rail.

6. A method of installing a roofing sheet on a structure having a roof and at least one wall, said method including the steps of:
securing a rail to a wall, the rail including a wall mounting portion, a ledge and a lip;
positioning a roofing sheet over the rail in a recess between the lip and the wall mounting portion; and
securing a clamp to the rail to contain the roofing sheet in the recess.
